(19) United States
(12) Patent Application Publication
(10) Pub. No.: US 2007/0245619 A1
(43) Pub. Date: Oct. 25, 2007

(54) Therapeutic candle

(76) Inventor: Kirsten Phillips, Olathe, KS (US)

Correspondence Address: LAW OFFICE OF BRETT N. DORNY, 386 WEST MAIN STREET, SUITE 12A, NORTHBOROUGH, MA, 01532, US

(21) Appl. No.: 11/412,146

(22) Filed: Apr. 25, 2006

(51) Int. Cl. C11C 5/00

(52) U.S. Cl. 44/275

(57) ABSTRACT

A therapeutic candle provides multiple sensory experiences. The candle includes bottle containing a mixture of liquid paraffin and essential oils. The bottle further contains natural objects, such as plants and rocks, within the mixture. A wick extends into the bottle and is lit. The use of essential oils provides aromatherapeutic effects when the candle is burned. A method of bonding the liquid paraffin and essential oils is also disclosed.

### BACKGROUND OF THE INVENTION

1. Field of the Invention

The present invention relates to liquid candles. More particularly, it relates to candles providing a therapeutic effect through excitation of the senses and aromatherapy.

2. Discussion of Related Art

Candles are often used in setting moods and conditions within a room. The soft glow of candle light is considered inviting. Furthermore, scented candles are used to enhance an atmosphere through the addition of various scents. People use different scents for different purposes. Generally, scented candles use a solid paraffin base to which the scent is added. When the candle is lit, the paraffin base melts and burns. The scent is then released into the air. The scent is also released simply through contact between the air and the candle. Typically, scented candles have a standard candle shape and are fairly plain in appearance. While scented candles can help create a mood through scents, they do not provide an entire sensory experience.

Aromatherapy has become increasingly popular. In aromatherapy, essential oils are used in various manners to affect physical and mental health. Essential oils are derived from natural products, such as flowers, nuts, seeds and plants. They can be used in lotions, creams, baths, and scents to create beneficial effects. Use of essential oils can be confusing. They cannot be easily combined with other sensations to create a complete sensory experience.

### SUMMARY OF THE INVENTION

The present invention provides a complete sensory experience through the use of liquid candles including essential oils. According to one aspect of the invention, the liquid candle is formed from a bottle or other transparent container. According to another aspect of the invention, the liquid candle includes an odorless, smokeless liquid paraffin. According to another aspect of the invention, essential oils are combined with the liquid paraffin. According to another aspect of the invention, the liquid candle includes a low burning wick. According to another aspect of the invention, materials are included in or on the bottle. According to another aspect of the invention, the materials are natural.

The present invention further provides a process for bonding essential oils with liquid paraffin for use in a therapeutic candle. According to one aspect of the invention, equal parts of essential oils and liquid paraffin are mixed together and left undisturbed for a period of time. According to one aspect of the invention, the period of time that the essential oils and liquid paraffin are left undisturbed is in the range of three to six hours. The mixture may then be combined with additional liquid paraffin within the liquid candle.

### BRIEF DESCRIPTION OF THE DRAWINGS

FIG. 1 illustrates a liquid candle according to an embodiment of the present invention.

### DETAILED DESCRIPTION

The present invention is a candle which provides an extensive sensory experience. The candle combines visual and aromatic elements for this experience. Furthermore, the candle uses essential oils for an aromatherapeutic effect.

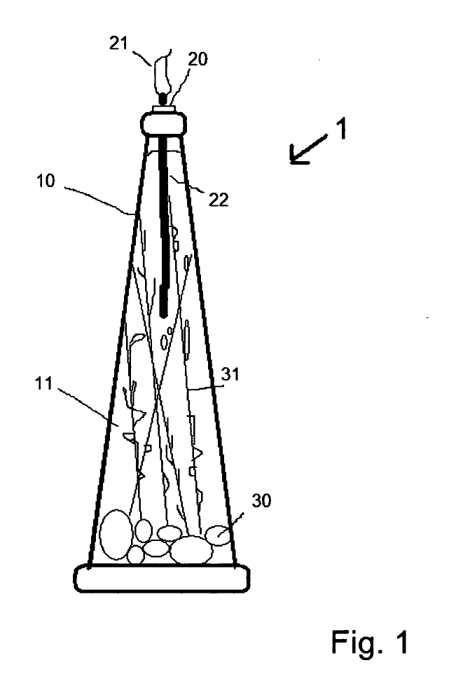

FIG. 1 illustrates a therapeutic candle 1 according to an embodiment of the present invention. The therapeutic candle 1 includes elements to enhance the sensory experience on several dimensions. The therapeutic candle 1 is contained in a bottle 10 or other transparent container. Preferably, a glass bottle is used. The glass bottle may be new or recycled. Other types of bottles or containers can also be used. The bottle 10 should be of a non-flammable, heat resistant material. The bottle 10 is transparent in order to aid in the visual aspects of the therapeutic candle 1.

To form a candle, a stop 20 having hole therethrough is positioned in the opening of the bottle 10. According to an embodiment of the invention, the stop 20 is a glass, or other heat resistant, bead with a hole therethrough. The stop 20 may be supported by the opening of the bottle 10. Alternatively, the stop 20 may float on top of the inflammable material forming the candle. A wick 22 extends through the hole in the stop 20 into the bottle 10 in order to contact a flammable mixture 11 within the bottle 10. The wick 22 is lit to produce a flame 21 creating a mood from the candle 1.

According to an embodiment of invention, the flammable mixture includes a liquid paraffin and at least one essential oil. Preferably, one to three essential oils are used in a candle. Essential oils are derived from plants and are known in aromatherapy. The combination of essential oils with the liquid paraffin creates therapeutic candle. Preferably, the liquid paraffin is an odorless and smokeless as it burns. A special process is used in order to bond the essential oil to the liquid paraffin in providing aromatherapy effect from the therapeutic candle 1. In accordance with this process, volumes of essential oils and liquid paraffin are mixed together. The mixture is then allowed to sit undisturbed for a period of time. Leaving mixture undisturbed allows the essential oils and liquid paraffin to bond so that they do not separate within the candle. After the bonding period, the mixture can be combined with additional liquid paraffin to adjust the amount of essential oils within the mixture. The essential oils remain bound to the liquid paraffin and do not separate. As the therapeutic candle 1 burns, the essential oils are released into the air providing the aromatherapy effect.

More specifically, in the process for bonding the essential oils and liquid paraffin, 1.5 fluid ounces of ultra pure, odorless and smokeless liquid paraffin is heated in a simmering potpourri pot until as warm as possible. Two teaspoons of coarse sea salt (without iodine) are added to the liquid paraffin. The mixture continues to be heated, stirring occasionally until the sea salt granules are completely dissolved. This process typically takes about 10 to 25 minutes depending upon the heating process of the potpourri pot. Once the sea salt is completely dissolved, the mixture is removed from the heat and 2.5 ml of essential oils are added. After adding the essential oils, the mixture is left undisturbed. The mixture is not stirred. The essential oils mix naturally with the liquid paraffin and sea salt over a period of 1 to 2 hours. After the mixture has cooled completely, it can be combined with additional liquid paraffin, up to an additional 48 ounces, to create the final mixture to be placed in the candle. The additional liquid paraffin may be colored to provide additional visual effects for the candle.

In addition to sensory experiences from the aromatherapy and the candle flame, the use of a transparent container allows enhanced visual stimuli. The liquid paraffin may be clear or a color. Colored paraffin enhances the visual effects. Furthermore, objects are placed in the bottle within the paraffin mixture to create a visual effect. According to embodiments of the invention, object may include combinations of plants 31, rocks 30, shells, marbles, sand or other natural and manmade materials (not shown). The objects can be chosen to provide variations in colors, textures and appearances. The bottle 10 may have different shapes to further enhance the visual effects. Finally, the outside of the bottle 10 may be decorated.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A therapeutic candle comprising:
a transparent container having an opening;
a wick extending through the opening of the transparent container such that a portion of the wick is inside the transparent container and a portion of the wick is outside the transparent container;
a flammable mixture of liquid paraffin and essential oils disposed within the transparent container and in contact with the wick.

2. The therapeutic candle according to claim 1, further comprising at least one object in the transparent container within the flammable mixture.

3. The therapeutic candle according to claim 2 wherein the least one object is a natural object.

4. The therapeutic candle according to claim 3, wherein the at least one object is a plant.

5. The therapeutic candle according to claim 3, wherein the at least one object is a rock.

6. A method for creating a flammable material for a liquid candle comprising the steps of:
heating a first volume of liquid paraffin;
adding a second volume of at least one essential oil to the liquid paraffin; and
leaving the mixture of liquid paraffin and essential oils undisturbed for a period of time.

7. The method of forming a flammable material for a liquid candle according to claim 6, wherein the first volume is approximately 1.5 fluid ounces and the second volume is approximately 2.5 ml.

8. The method of forming a flammable material for a liquid candle according to claim 6, further comprising, before the adding step:
adding a third volume of sea salt to the liquid paraffin; and
heating and stirring the liquid paraffin until the sea salt is dissolved.

9. The method of forming a flammable material for a liquid candle according to claim 7, wherein the first volume is approximately 1.5 fluid ounces, the second volume is approximately 2.5 ml, and the third volume is approximately 2 teaspoons.

10. The method of forming a flammable material for a liquid candle according to claim 6, further comprising the step of combining the mixture with a fourth volume liquid paraffin following the leaving step.

11. The method of forming a flammable material for a liquid candle according to claim 10, wherein the fourth volume is less than 48 fluid ounces.

12. A flammable mixture for use in a liquid candle, the mixture comprising:
liquid paraffin; and
at least one essential oil.

13. The flammable mixture for use in a liquid candle according to claim 12, wherein the mixture comprises approximately 2.5 ml of at least one essential oil in approximately 48 ounces of liquid paraffin.

14. The flammable mixture for use in a liquid candle according to claim 12, further comprising sea salt.
